(19) United States
(12) Patent Application Publication
(10) Pub. No.: US 2004/0062894 A1
(43) Pub. Date: Apr. 1, 2004

(54) Method of packaging solvent or water based formulations to reduce skinning

(76) Inventors: Antony Keith Van Dyk, Upper Hutt (NZ); Colin Gooch, Upper Hutt (NZ)

Correspondence Address: WILDMAN, HARROLD, ALLEN & DIXON, 225 WEST WACKER DRIVE, CHICAGO, IL, 60606, US

(21) Appl. No.: 10/644,711

(22) Filed: Aug. 20, 2003

Related U.S. Application Data
(62) Division of application No. 09/831,489, filed on Aug. 10, 2001.
Application No. 09/831,489 is a 371 of international application No. PCT/NZ99/00188, filed on Nov. 10, 1999.

(30) Foreign Application Priority Data
Nov. 10, 1998 (NZ) 332735

(51) Int. Cl. F16L 1/00

(52) U.S. Cl. 428/36.1; 428/34.1

(57) ABSTRACT

The present invention relates to packaging water or solvent based formulations, in particular to those formulations which are prone to skinning. The invention comprises a container that is adapted to contain such a formulation in which an anti-skinning layer is located between at least a portion of an internal surface of the container or a lid and the formulation.

### FIELD OF THE INVENTION

The present invention relates generally to a method of packaging water or solvent based formulations, such as paints, resins and glues. In particular the present invention relates to a method of packaging such formulations which minimises skinning of the formulation on the internal surfaces of containers in which the formulation is stored.

### BACKGROUND

It is known to store water-based or solvent based formulations in containers. Such containers have a lid or sealing means to isolate the formulation from the surrounding atmosphere.

Commercially available paints are generally stored in a number of different sized containers. The container size may range from ten millilitres through to 50,000 litres.

Paint containers which contain approximately 1 litre through to 50,000 litres of a paint formulation are vulnerable to the forming of a skin on the internal surfaces of the container upon storage. The skin is a film of paint which is in contact with the lid and typically the upper internal side of the paint container. The skinning of paints in paint containers is a recognised problem in the industry and occurs in containers made out of plastics or metals. If the skinning is quite considerable it may be necessary in some instances to sieve the paint formulation to remove the skin prior to using the paint.

Skinning on the surface of solvent based (alkyd) paint has been known for many decades. The mechanism is known to involve the uptake of oxygen leading to the oxidative cross-linking (skinning) of the paint. There are various additives that are known which can be used in alkyd paints to inhibit premature crosslinking.

Typically, volatile oximes are used to chelate to the polymerisation catalysts (typically transition metals, such as cobalt, salts of organic acids such as octanoic acid or naphthenic acid) and inhibit the activity in the wet state. Methyl ethyl ketoxime is commonly used as an anti skin additive in alkyd paints.

Otherwise, means or methods of preventing or reducing skinning of paints in containers are unknown, other than the impractical and hazardous method of excluding the formulation vapour from the containers.

The skinning of paint is particularly pronounced when paint containers are stored under varying external temperature conditions. The occurrence of skinning has been found to be more prevalent during the warmer conditions of summer.

It is an object of the present invention to alleviate some of the skinning difficulties experienced in the paint industry, or to at least provide the public with a useful choice.

The terms “anti-skinning” and “prone to skinning” as used throughout this specification are to be construed to include instances of skinning that occur by water or solvent loss from the formulation. These terms are not to be construed to include instances of skinning involving the uptake of oxygen leading to the oxidative cross-linking of the formulation.

### SUMMARY OF THE INVENTION

The present invention provides a container, which is adapted to contain a water based or solvent based formulation, the container including

an anti-skinning layer located on at least a portion of the internal surface of the container and the formulation, wherein the anti-skinning layer is capable of retaining a layer of the formulation without excluding the formulation vapour in the container from contacting the formulation.

Preferably, the anti-skinning layer substantially maintains the water or solvent concentration of a portion of the formulation retained on the anti-skinning layer.

Preferably, the anti-skinning layer is textured, porous, fibrous, filamentous, a gauze, or foam lining.

Preferably, the anti-skinning layer additionally has insulative properties.

Preferably, the anti-skinning layer is integrally moulded into the internal surface of the container.

Preferably, the container contains approximately 10 ml to 50,000 litres of formulation.

Preferably, the water based or solvent based formulation is a formulation prone to skinning, such as a latex based paint, an alkyd paint, a flat, a satin, a semi-gloss or a gloss paint, a varnish, a lacquer, a glue or resin such a PVA™, a resin emulsion or a water based ink.

In another aspect the present invention provides a container, which is adapted to contain a water based or solvent based formulation, the container including

a container sealing means including an anti-skinning layer located on at least a portion of the internal surface of the sealing means, wherein the anti-skinning layer is capable of retaining a layer of the formulation without excluding the formulation vapour in the container from contacting the formulation.

Preferably, the anti-skinning layer substantially maintains the water or solvent concentration of a portion of the formulation retained on the anti-skinning layer.

Preferably, the anti-skinning layer is textured, porous, fibrous, filamentous a gauze, or foam lining.

Preferably, the anti-skinning layer additionally has insulative properties.

Preferably, the anti-skinning layer is located on the internal surface of the sealing means and integrally moulded with the container sealing means.

Preferably, the container contains approximately 10 ml to 50,000 litres of formulation, and the sealing means is a resealable lid.

In another aspect of the present invention there is provided a container adapted to contain a water based or solvent based formulation and a container sealing means as described above, the container being further adapted to include a second anti-skinning layer on the internal surface of the container.

Preferably, the second anti-skinning layer is textured.

Preferably, the second anti-skinning layer is integrally moulded into the container.

Preferably, the second anti-skinning layer is located between the circumferential lip of the container and the formulation.

Preferably, the second anti-skinning layer is an integrally moulded series of spaced apart concentric ribs moulded into a plastics container between the top of the container proximate the sealing means to at least the formulation level.

Preferably, the texturing extends at least 1-10 microns (0.001-0.01 mm) from the internal surface of the container.

In a further aspect of the present invention there is provided a method of preventing skin formation on a water based or solvent based formulation, the method including the steps of

placing the water based or solvent based formulation in a container as described above, and

storing or transporting the formulation.

Preferably, the anti-skinning layer is textured, having insulative properties and is located proximate the internal surface of the sealing means.

Preferably, the container contains between 10 ml to 50,000 litres of formulation, and the sealing means is a resealable lid.

In a further aspect of the present invention there is provided a sealing means, the sealing means being adapted to substantially control skinning of water based or solvent based formulations, in which the sealing means includes an anti-skinning layer in which the layer is located on at least a portion of the inner surface of the sealing means, wherein the antiskinning layer when in use on a container is adapted to contain a water-based or solvent based formulation, is capable of retaining a layer of the formulation without excluding the formulation vapour in the container from contacting the formulation.

Preferably, the anti-skinning layer is approximately 0.001 millimetres to 5 centimetres thick, is textured and is located on the internal surface of the sealing means.

Preferably, the anti-skinning layer covers substantially the entire surface area of the internal surface of the sealing means, and the sealing means is a resealable lid.

In a further aspect the present invention provides a container including a sealing means, in which the container is adapted to contain a formulation prone to skinning by loss of water or solvent, wherein at least a portion of the internal surface of the container in proximity with the ullage space of the container has a means of retaining a layer of the formulation, without excluding the formulation vapour in the container from contacting the formulation.

Preferably, the means is a textured anti-skinning layer from 0.001 to 5 mm thick, which substantially covers the internal surface of the sealing means.

Preferably, the anti-skinning layer is porous, has insulative properties and is integrally moulded onto the internal surface of the sealing means.

Preferably, the anti-skinning layer is selected from a group consisting of woven or unwoven polyolefin cloth or gauze, artificial grass matting and glass fibre felt and is thermally bonded to a plastics sealing means.

The term “insulative properties”, as used in this specification with reference to the anti-skinning layer, is used to refer to a layer that has the properties of reducing temperature and concentration differentials within the container interior, and modulating heat transfer between the environment and the container interior.

Further aspects of the present invention will become apparent from the following description given by way of example and with reference to any one of the following figures, in which:

FIG. 1 illustrates a container adapted to contain a water or solvent based formulation and a lid means comprising a lid liner.

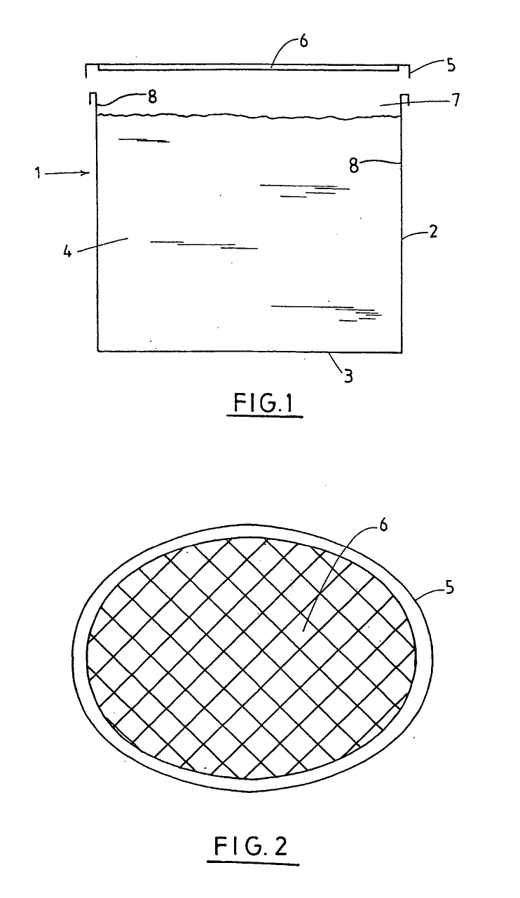

FIG. 2 illustrates the internal surface of a lid means including a lid liner.

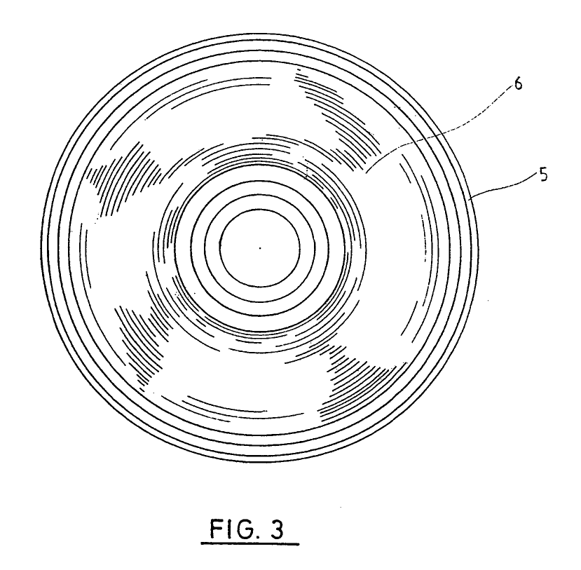

FIG. 3 illustrates a textured pattern on the internal surface of a lid.

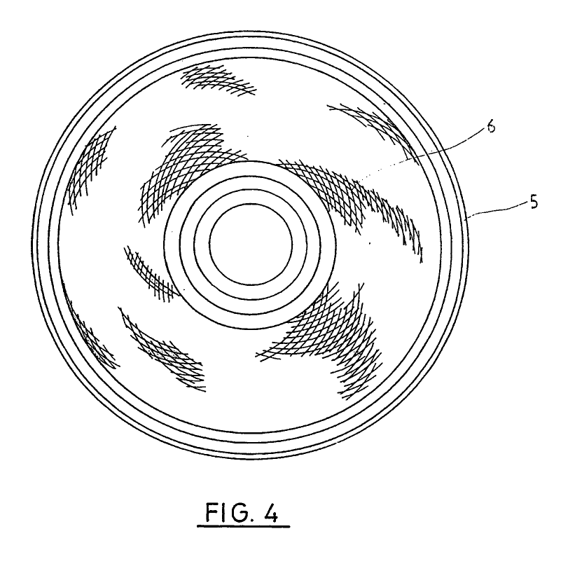

FIG. 4 illustrates an alternative textured pattern on the internal surface of a lid.

### DETAILED DESCRIPTION OF THE INVENTION

A solvent or water based formulation container 1 is illustrated in FIG. 1. The container preferably, comprises substantially upright walls 2 and a base means 3. A water based or solvent based formulation 4 is contained within the container. Preferably, the formulation substantially fills the container. The container may be adapted to contain approximately 10 ml to 50,000 litres of formulation 4.

A sealing means or lid 5 is adapted to cover the formulation 4 in the container 1 and to substantially exclude ingress of the external atmosphere into the internal compounds of the container and loss of the internal atmosphere out of the container. Preferably, the container lid is adapted to be substantially airtight when located securely on the container.

An internal surface layer or lining 6 located on the lid is illustrated in FIG. 1. The layer or lining 6, preferably substantially covers the entire internal surface of the lid means. In some instances there may be an ullage or space 7, between the formulation 4 and the lid liner 6. The internal surface of the container 8 can be either in contact with the formulation or in contact with the vapour of the formulation as shown in FIG. 1.

In FIG. 2 the inner surface of the lid 5 is illustrated with a covering liner 6.

During storage of containers of formulations of solvent or water based mixtures, the container 2, the formulation 4, the ullage 7 and the lid means 5 all form part of a system which is vulnerable to temperature changes. When the surrounding environment of the container is constant, the temperatures of the container, the formulation and the ullage space is substantially equal to the temperature of the external environment. The vapour arising from the formulation is maintained in the ullage space between the internal surface of the lid and the body of the formulation. It has been established that no skinning occurs under conditions whereby the temperature of the container, the body of the formulation and ullage space are at equilibrium. To maintain such a temperature equilibrium from the time of filling the container to storage and ultimately to the time just prior to the use of the formulation would require very expensive atmospheric control means.

However, when the temperature of the external environment increases, for example, where the container is sitting in sunlight, the external surface of the container and lid can increase while the corresponding temperature of the formulation within the container, the vapour in the ullage 7, and the lid surface can be substantially different. The temperature of the lid 5 and the adjacent formulation vapour in the ullage 7 increases in temperature more quickly than the body of the formulation 4. A temperature gradient may be created between the lid and the body of the formulation.

It has been established that under conditions of storage of containers 1 where the temperature of the external atmosphere is not maintained at a steady state, the formulation has a tendency to skin proximate to the lid of the container. This is thought to arise because of the temperature gradient and thereby concentration gradient of vapour existing between the lid and the formulation.

In a closed and substantially watertight container there is only limited scope for the drying of paint. Under equilibrium conditions the air in the ullage space 7 is saturated with a concentration of water or solvent vapour, which depends on the composition of the paint or formulation. Generally, for a water based formulation the concentration of water vapour is above 90%. Skinning of paint does not normally occur under these conditions. It has been established that pails of paint stored at 25±2° C. for 3 months have not skinned. However, pails of the same paint skinned, when subjected to a single heating cycle exceeding about 5° C. It has been found that the greater the heating step, the greater the degree of skinning.

The temperature gradients create concentration gradients of water or solvent vapour. The air proximate to the layer of formulation on the lid becomes dry when the lid is heated and water is lost from the layer of paint.

In typical storage conditions it is difficult and expensive to maintain temperature to within one or two degrees Centigrade. However the issue is the rate of change of temperature, where sudden changes are worse than gradual changes. Lids are prone to skinning because they have only weak thermal coupling to the body of paint, the main heat reservoir. Lids are forced to follow ambient temperatures, while the paint in the body of the container responds more sluggishly to temperature changes. Metal containers have better thermal conduction properties than do typical plastic containers. Temperature differentials are generally less for metal containers than they are for plastic containers. Metal containers are known to be less prone to skinning.

While the mechanism of skinning is as discussed there are two additional aspects. One is that by retaining a thicker layer of paint on the inner surface of container there is better thermal coupling to the body of paint. This acts to reduce the temperature differential that occurs between the lid and the body of paint or formulation. Some paints are inherently thicker than others and will naturally form thicker films which are less prone to skinning under these conditions. Another aspect of the mechanism is that the evaporation of water or solvent vapour from the paint acts to carry away heat, which also acts to reduce the temperature differential. Both these additional effects are only effective as long as the layer of paint remains substantially fluid. By retaining a thicker layer of paint, and thereby a greater concentration of water or solvent proximate the inner surfaces of both the container, around the ullage space, and proximate the internal surface of the lid, the time of wetness is prolonged compared to that observed with conventional lid surfaces. This provides a method of extended thermodynamic cooling because of evaporation of the water or solvent from the thicker layer of retained formulation. Additionally, it is thought that the thermal conductivity is greater between the lid and thicker layer of retained formulation and the bulk of the formulation.

In order to minimise the concentration and temperature gradient arising under conditions whereby the external temperature of the container 1 is not maintained at a constant value, it has been found that the incorporation of a textured, porous, fibrous, filamentous, gauze or foam-like layer of approximately 0.001 to 5 mm either suspended between the lid and formulation or located on or integrated with the internal surface of the lid can control skinning. The results of a particular experiment illustrating the effects of the skinning control measures achieved from various linings are illustrated in the following examples.

Example 1—Pails of water based high solids acrylic undercoat were placed in an incubator at 40° C. for one day. The initial temperature of the containers was conditioned to 24° C. The container contained 10 litres of formulation. A container, comprising a non-lined lid was used as a reference. The amount of skin formed in the reference container was 11.2 grams. The degree of skinning was determined by removing the skin off the lid with a soft brush under water into a 500 μm test sieve. The skin which was collected was spun dry, weighed and bottled for future reference.

The lid liners that were compared are illustrated in the following table.

| Lid Lining Means | Skin Percentage |
|---|---|
| Untreated container (reference) | 100% |
| Plastic sheet lid liner¹ | 38% |
| Container insulation² | 22% |
| Internal polystyrene float | 17% |
| Fibreglass gauze on lid | 3% |

¹The single ply plastic sheet tested was 75 micron polyethylene, 75 g per square metre per ply.
²Insulation means included the likes of cardboard, paper, cardboard laminated with aluminium foil, bubble wrap and aluminium foil, fibreglass laminated with aluminium foil.

Example 2—As in Example 1 a test with the plastic sheet was repeated. In this instance the plastic sheet (1 or 2 ply) was suspended between the lid and the formulation surface. With 1 ply the skinning reduced to 20% and with 2 ply to slightly less than 20%.

Example 3—As in Example 1 a nylon gauze of 200 micron aperture size, 230 micron gauze thickness and 100 g per square meter was fixed against the lid of a container. The nylon gauze layer was attached to the inner surface of the lid using hot melt adhesive. There was a gap of approximately 0.5 to 1 mm between the gauze and the lid. This gap and gauze was observed to retain significant amounts of paint approximately 1-3 mm. The skinning results were reduced to approximately 3%.

Example 4—As in Example 3, spun glass fibre felt of 500 microns thick and 160 g per square meter was attached with hot melt adhesive to the lid. The skinning results were reduced to approximately 3%.

Example 5—A polystyrene float of 2.5 cm thick and 360 g per square meter was cut out to substantially cover the surface of the formulation. The float was substantially immersed in the formulation and allowed to float on the top surface of the formulation. The skinning results were reduced to approximately 3%.

Example 6—An integrally moulded plastics lid having an integrally moulded textured or profiled inner plastics surface, in which the texture is approximately 0.5-1.0 mm in thickness and substantially covering the entire area of the inner surface was investigated. The skinning results using the method of Example 1 were reduced to approximately 18-27%. The degree of skinning has been found to vary depending on the pattern of texturing moulded onto the surface. The textured patterns trialed include a spiral groove producing a textured pattern shown in FIG. 3 and a double spiral groove producing a textured pattern as illustrated in FIG. 4.

Example 7—Sandblasted, scratched or sanded internal plastics surfaces were also trialed under conditions as in Example 1. A reduction in skinning of between 25-40% compared to an unmodified smooth internal plastics surface was achieved.

Example 8—An integrally moulded polypropylene cloth or gauze on the internal surface of a plastics lid gave complete prevention of skinning under the method described in Example 1.

The polypropylene cloth used in this example has a nominal thickness of 1.5 mm. It has been established that when this polypropylene cloth is compressed that the thickness is less than about 0.2 mm. The effective thickness of the polypropylene cloth on the lid is estimated to be about 0.2 mm, when the lid and cloth are injection moulded together. It has been established that the thickness of the polypropylene cloth may be varied considerably. However, during the trials there was always sufficient texture or cloth remaining exposed even in the most significantly polypropylene bonded injection moulded lid confering near complete resistance to formulation skinning under the conditions described in example 1.

The polypropylene cloth employed had a weight of 410 grams per square metre and is composed of fibres having a typical diameter or 40 microns. The weave of the polypropylene would be considered to someone skilled in the art as being a fairly coarse weave and having a rather random pattern of weave.

Several varieties and types of cloth have been tested and all have the desired effect of entraining a layer of paint against the fibres/texture of the cloth and thereby reducing skinning.

Example 9—A layer of polypropylene artificial grass matting (Astroturf™) adhered to an internal surface of a plastics lid has also been found to give complete prevention of skinning when used in the method of Example 1.

Example 10—A trial was also conducted using a plastics 10L container wherein the internal side walls of the container were textured with a polypropylene cloth adhered to the side walls of the container.

Two ten litres pails full of paint (an acrylic primer undercoat of high solids) were employed for this example. Both pails used polypropylene cloth fused to the lid during injection moulding as described in example 8 above.

The internal side walls of one pail body were unmodified, while the other pail body had a 4 cm wide strip of polypropylene cloth hot melt glued to the internal side wall of the pail, about 3 cm of which remained above the paint level held in the pail. Essentially, the internal space of the pail body corresponding to the ullage was modified by the adhering of the polypropylene strip to the wall. The paint for both pails was conditioned to 25° C. The pails were filled with the paint, the lids attached and the pails inverted and shaken for 30 seconds to thoroughly wet all internal surfaces. The pails were then placed in an incubator at 40° C. for two days.

The first pail with the polypropylene cloth modified lid and the unmodified pail body produced traces of less than 0.1 gram of paint on the lid and approximately 5.9 grams of skin from the internal side walls of the pail, principally in the ullage space.

The other test pail where the internal side walls of the pail were modified by including the polypropylene strip resulted in no trace of skinning. Furthermore, there was no skin on the exposed flanges. The internal flanges of the pail were not covered with polypropylene cloth. This result was somewhat surprising, given that the flanges are approximately a 5 mm flat face and traditionally prone to skinning.

This result supports that there appears to be a measure of projected humidification from the cloth areas preventing the skinning of paint at these positions.

These results can be compared to those where the same trial was conducted using an unmodified pail and an unmodified lid. Under equivalent conditions described above, approximately 15-25 gms of skin formed on the lid and the pail. On the lid 10-15 gms of skin would form, while on the internal side walls of the pail approximately 5-10 gms of skin formed.

The examples illustrate that the combinations of control measures provide substantial improvements in skinning control.

All the measures tested resulted in significantly less skin formulation arising from the formulation compared to the untreated container.

It is an advantage of the present invention that the degree of skinning on formulations of water based or solvent based products may be substantially controlled.

It has also been recognised during experimental trials that when using a textured anti-skinning layer that when conditions are sever or such that skinning does actually occur the layer of skinned paint is retained on the textured layer. The skinned paint does not fall into the body of the formulation as has been traditionally observed when using conventional formulation containers.

Where in the foregoing description reference has been made to integers or components having known equivalents, then such equivalents are herein incorporated as if individually set forth.

Although the invention has been described by way of example and with reference to possible embodiments it is to be appreciated that improvement and/or modifications may be made to these embodiments without departing from the scope of the invention.

What we claim is:

1. A container adapted to contain a water based or solvent based formulation, the container including
an anti-skinning layer located on at least a portion of the internal surface of the container, wherein the anti-skinning layer is capable of retaining a layer of the formulation without excluding the formulation vapour in the container from contacting the formulation.

2. A container according to claim 1, wherein the anti-skinning layer substantially maintains the water or solvent concentration of any of the water or solvent based formulation retained on the anti-skinning layer.

3. A container according to claim 1 or claim 2 in which the anti-skinning layer is textured.

4. A container according to any one of claims 1 to 3, wherein the anti-skinning layer is porous, fibrous, filamentous, a gauze or foam lining.

5. A container according to any one of claims 1 to 4 in which the anti-skinning layer additionally has insulative properties.

6. A container according to any one of claims 1 to 5 in which the anti-skinning layer is integrally moulded or adhered onto the internal surface of the container.

7. A container according to any one of claims 1 to 6 in which the anti-skinning layer is thermally bonded onto the internal surface of the container.

8. A container according to any one of claims 1 to 7 in which the container is adapted to contain approximately 10 ml to 50,000 litres of formulation.

9. A container according to any one of claims 1 to 8 in which the water based or solvent based formulation is a formulation prone to skinning.

10. A container according to claim 9 in which the formulation prone to skinning is a latex based paint, an alkyd paint, a flat, a satin, a semi-gloss or a gloss paint, a varnish, a lacquer, a glue or resin such as PVA™, a resin emulsion or a water based ink.

11. A container adapted to contain a water based or solvent based formulation, including
a container sealing means including an anti-skinning layer located on at least a portion of the internal surface of the sealing means, wherein the anti-skinning layer is capable of retaining a layer of the formulation, without excluding the formulation vapour in the container from contacting the formulation.

12. A container according to claim 11 wherein the anti-skinning layer substantially maintains the water or solvent concentration of any of the water or solvent based formulation retained on the anti-skinning layer.

13. A container according to claim 11 or claim 12, in which the anti-skinning layer substantially covers the internal surface of the sealing means.

14. A container according to any one of claims 11 to 13 in which the anti-skinning layer is textured.

15. A container according to any one of claim 11 to 14, in which the anti-skinning layer is porous, fibrous, filamentous, a gauze or foam lining.

16. A container containing according to any one of claims 11 to 15 in which the anti-skinning layer has insulative properties.

17. A container according to any one of claims 11 to 16 in which the anti-skinning layer is integrally moulded or adhered onto the container sealing means.

18. A container according to any one of claims 11 to 17 in which the anti-skinning layer is thermally bonded onto the internal surface of the container.

19. A container according to any one of claims 11 to 18 in which the container is adapted to contain approximately 10 ml to 50,000 litres of formulation.

20. A container according to any one of claims 11 to 19 in which the sealing means is a resealable lid.

21. A container according to any one of claims 11 to 20 in which the water based or solvent based formulation is prone to skinning.

22. A container according to claim 21 in which the formulation prone to skinning is a latex based paint, an alkyd paint, a flat, a satin, a semi-gloss or a gloss paint, a varnish, a lacquer, a glue or resin such as PVA™, a resin emulsion or a water based ink.

23. A container according to any one of claims 11 to 22, in which the container includes a second anti-skinning layer extending about at least a portion of the internal surface of the container and the formulation.

24. A container according to claim 23, in which the second anti-skinning layer is located between the circumferential lip of the container and the formulation.

25. A container according to claim 23 or claim 24 in which the second anti-skinning layer is textured.

26. A container according to any one of claims 23 to 25, in which the second anti-skinning layer is integrally moulded or adhered onto the internal surface of the container.

27. A container according to any one of claims 23 to 26 in which the second anti-skinning layer is thermally bonded onto the internal surface of the container.

28. A container according to any one of claims 23 to 26 in which the second anti-skinning layer is an integrally moulded series of spaced apart concentric ribs integrally moulded into a plastics container between the top of the container proximate the sealing means to at least the formulation level.

29. A container according to claim 28 in which the integrally moulded series of ribs extend from the top of the internal surface of the container proximate to the sealing means substantially to the container base.

30. A method of preventing skin formation on a water based or solvent based formulation, the method including the steps of:
placing the water based or solvent based formulation in a container according to any one of claims 1 to 29, and
storing or transporting the formulation.

31. A sealing means adapted to substantially control skinning of water based or solvent based formulations, in which the sealing means includes an anti-skinning layer, in which the layer is located on at least a portion of the inner surface of the sealing means, wherein the anti-skinning layer, when in use on a container adapted to contain a water-based or solvent based formulation, is capable of retaining a layer of the formulation, without excluding the formulation vapour in the container from contacting the formulation.

32. A sealing means according to claim 31 wherein the anti-skinning layer substantially maintains the water or solvent concentration of any of the water or solvent based formulation retained on the anti-skinning layer.

33. A sealing means according to claim 31 or claim 32 in which the anti-skinning layer is textured.

34. A sealing means according to any one of claims 31 to 33 in which the anti-skinning layer is porous, fibrous, filamentous, a gauze or foam lining.

35. A sealing means according to any one of claims 31 to 34 in which the anti-skinning layer has insulative properties.

36. A sealing means according to any one of claims 31 to 35 in which the anti-skinning layer is approximately 0.001 mm to 5 cm thick.

37. A sealing means according to any one of claims 31 to 36 in which the anti-skinning layer is integrally moulded or adhered onto the internal surface of the sealing means.

38. A sealing means according to any one of claims 31 to 37 in which the anti-skinning layer is thermally bonded onto the internal surface of the sealing means.

39. A sealing means according to any one of claims 31 to 38 in which the anti-skinning layer covers substantially the entire surface area of the internal surface of the sealing means.

40. A sealing means according to any one of claims 31 to 39, in which the sealing means is a resealable lid.

41. A container including a sealing means, in which the container is adapted to contain a formulation prone to skinning by loss of water or solvent wherein at least a portion of the internal surface of the container in proximity with the ullage space of the container has a means capable of retaining a layer of the formulation, without excluding the formulation vapour in the container from contacting the formulation.

42. A container according to claim 41 wherein said means substantially maintains the water or solvent concentration of the layer of formulation retained.

43. A container according to claim 41 or claim 42 in which the means is an anti-skinning layer from 0.001 to 5 mm thick.

44. A container according to any one of claims 41 to 43 in which the anti-skinning layer substantially covers the internal surface of the sealing means.

45. A container according to claim 41 or claim 44 in which the anti-skinning layer is textured.

46. A container according to any one of claims 41 to 45 in which the anti-skinning layer is porous, fibrous, filamentous, a gauze or foam lining.

47. A container according to any one of claims 41 to 46 in which the anti-skinning layer has insulative properties.

48. A container according to any one of claims 41 to 47 in which the anti-skinning layer is integrally moulded or adhered to the internal surface of the sealing means.

49. A container according to any one of claims 41 to 48, in which the anti-skinning layer is selected from a group consisting of woven or unwoven polyolefin cloth or gauze, artificial grass matting and glass fibre felt.

50. A container according to claim 49 wherein the layer is thermally bonded to a plastics sealing means.

51. A container according to claim 50 wherein the plastics sealing means is a resealable lid.
